(19) United States
(12) Patent Application Publication
(10) Pub. No.: US 2010/0289312 A1
(43) Pub. Date: Nov. 18, 2010

(54) VEHICLE SEAT, IN PARTICULAR COMMERCIAL VEHICLE SEAT

(76) Inventors: Michael Burr, Langwieden (DE); Christof Steiner, Kaiserslautern (DE); Thomas Jung, Wahnwegen (DE); Rüdiger Nissen, Freisen-Oberkirchen (DE); Thomas Weber, Kaiserslautern (DE)

Correspondence Address: MCGLEW & TUTTLE, PC, P.O. BOX 9227, SCARBOROUGH STATION, SCARBOROUGH, NY, 10510-9227, US

(21) Appl. No.: 12/863,655

(22) PCT Filed: Apr. 28, 2009
(86) PCT No.: PCT/EP2009/003061

§ 371 Date: Jul. 20, 2010

(30) Foreign Application Priority Data
May 7, 2008 (DE) 10 2008 023 120.

(51) Int. Cl. B60N 2/50

(52) U.S. Cl. 297/313

(57) ABSTRACT

A vehicle seat is provided, in particular a commercial vehicle seat, having a scissor-type stand (3) that can vibrate and comprises a bottom frame (5), a top frame (7), two first rocker arms (8a) and two second rocker arms (8b) that intersect in pairs at a scissor axis (10) extending in a transverse seat direction (y). At least one first rocker arm (8a) is supported at one end by at least one bearing mechanism (20) on the top frame (7) or on the bottom frame (5) so as to be able to rotate and vibrate in the longitudinal seat direction (x). The at least one bearing mechanism (20) has at least one damping spring (26), which elastically absorbs and dampens vibrations in the longitudinal seat direction (x).

### CROSS REFERENCE TO RELATED APPLICATIONS

This application is a United States National Phase application of International Application PCT/EP2009/003061 and claims the benefit of priority under 35 U.S.C. §119 of German Patent Application DE 10 2008 023 120.7 filed May 7, 2008, the entire contents of which are incorporated herein by reference.

### FIELD OF THE INVENTION

The invention relates to a vehicle seat, in particular a commercial vehicle seat, having a scissors-type stand that can vibrate and which comprises a bottom frame and a top frame.

### BACKGROUND OF THE INVENTION

A vehicle seat of this type and known from use has a transverse bar as a viscoelastic element, which is fastened at the end to the top frame and centrally to the rear transverse tube, in order to dampen vibrations of the scissors-type stand in the longitudinal seat direction.

### SUMMARY OF THE INVENTION

The object of the invention is to improve a vehicle seat of the aforementioned type.

According to the invention, a vehicle seat, in particular a commercial vehicle seat, is provided comprising a bottom frame, a top frame, two first rocker arms and two second rocker arms. One of the first rocker arms intersects with one of the second rocker arms to form an intersecting pair with a scissor axis extending in a transverse seat direction. Another of the first rocker arms intersects with another of the second rocker arms to form another intersecting pair with a scissor axis extending in a transverse seat direction. The bottom frame, the top frame, the two first rocker arms and two second rocker arms form a scissors-type stand that can vibrate. A bearing mechanism supports at least one of the two first rocker arms on the top frame or on the bottom frame so as to be able to rotate and vibrate in a longitudinal seat direction. The bearing mechanism has at least one damping spring elastically absorbing and dampening vibrations in the longitudinal seat direction.

As a result of the bearing mechanism, the scissors-type stand may absorb and dampen vibrations in the longitudinal seat direction. The bearing mechanism bears at least the end of a first rocker arm (or one of the second rocker arms), by preferably receiving a transverse tube which preferably connects the ends of the two first rocker arms to one another. The desirable ability of the end of the first rocker arm to vibrate, i.e. in particular of the transverse tube, is achieved by means of at least one damping spring, which elastically absorbs and dampens vibrations in the longitudinal seat direction. The term “transverse tube” is not intended to be restricted to circular cross sections and to hollow profiles, but generally to denote the component connecting the rocker arms (or a component in turn connected thereto, for example a pin in the transverse seat direction).

The damping spring preferably consists of a resilient material which dissipates energy, in particular an elastomer, but may also consist of resilient and damping elements in two parts or multiple parts. The bearing mechanism preferably has at least one sliding frame which is fastened to the associated frame (top frame or bottom frame) and into which one end of the transverse tube may be inserted. As the transverse tube is connected to the first rocker arms, said rocker arms are therefore mounted on the associated frame. The transverse tube may be directly inserted into the sliding frame, but is preferably received by a sliding piece which is movably arranged in the sliding frame. The damping spring is preferably arranged between the sliding frame and the sliding piece, for example in the sliding frame one respective damping spring is arranged in the longitudinal seat direction in front of and behind the sliding piece.

If, depending on the driving situation, it is not desirable for the scissors-type stand to absorb and dampen vibrations in the longitudinal seat direction, by means of a locking device the end of the first rocker arm, i.e. in particular the transverse tube, may be locked to the associated frame (depending on the mounting, the top frame or bottom frame), and as a result of which the vibrations, i.e. the relative movements between the ends of the scissors and the associated frame, are suppressed in the longitudinal seat direction.

The locking device has, for example, a support and preferably a half-bushing, which at least partially encloses the transverse tube in the peripheral direction thereof. The half-bushing may, for example, be clipped onto the transverse tube and preferably subsequently connected to the support, for example positively inserted into the support. This permits an installation of the locking device depending on the assembly of the seat frame. The support is preferably movably guided and secured relative to the associated frame (top frame or bottom frame), for example by means of a slot-pin guide, consisting of a slot—extending expediently in the longitudinal seat direction—in the associated frame and a sliding pin—preferably able to be attached from outside.

In order to lock the locking device, preferably a locking bar is provided which is movable relative to the support and which cooperates with the associated frame (top frame or bottom frame), in particular by means of at least one locking bar projection, using at least one locking opening of the associated frame. The locking bar is preferably movably guided and secured by means of a further slot-pin guide relative to the support consisting of a slot in the support—extending expediently transversely to the longitudinal seat direction—and a sliding pin—preferably able to be attached from outside. A pretensioning of the locking bar maintains a locked state, whilst the other locked state is achieved by means of a control cable or the like.

The invention is described in more detail hereinafter with reference to an exemplary embodiment shown in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective partial view of the exemplary embodiment in the region of the scissors-type stand with the bearing mechanism and locking device;

FIG. 2 is an exploded view of the locking device;

FIG. 3 is an exploded view of the bearing mechanism; and

FIG. 4 is a schematic side view of the exemplary embodiment.

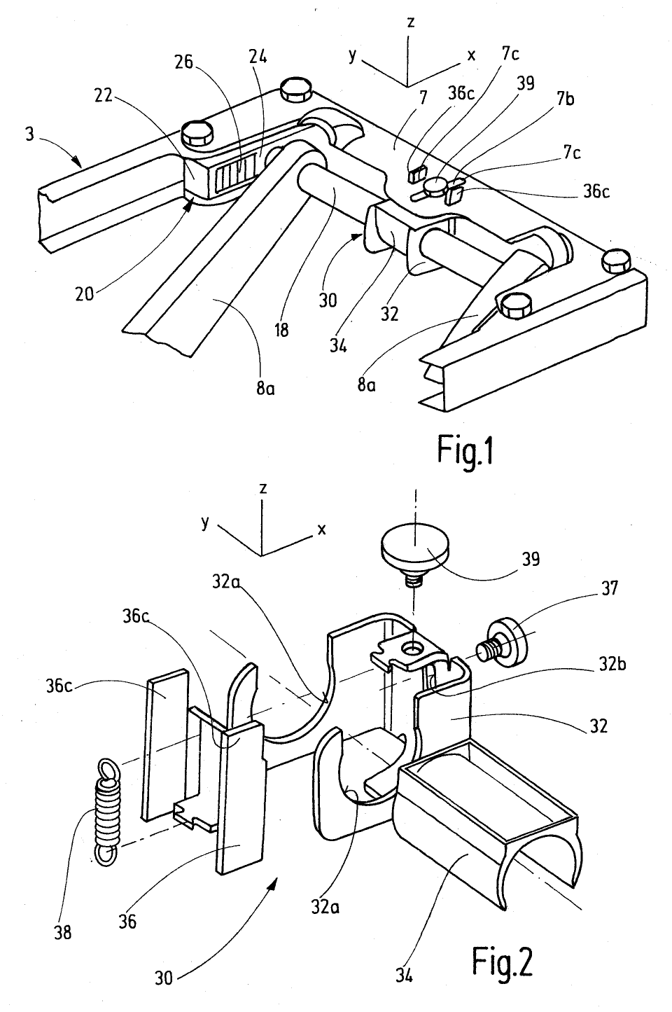

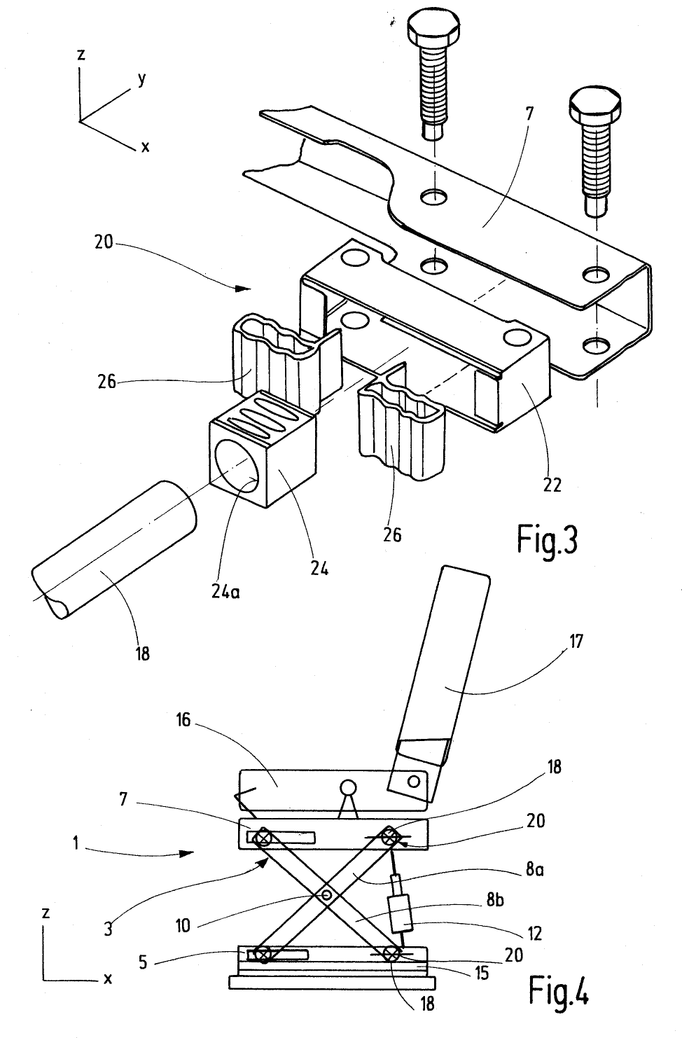

### DESCRIPTION OF THE PREFERRED EMBODIMENTS

Referring to the drawings in particular, a vehicle seat 1 for a commercial vehicle or a different type of motor vehicle has a scissors-type stand 3, which comprises a bottom frame 5, a top frame 7 arranged above said bottom frame, and on both sides one respective pair of intersecting rocker arms 8a and 8b. A scissor axis 10 connects the two points of intersection and at the same time defines the axis extending in the transverse seat direction y, about which the rocker arms 8a and 8b may pivot relative to one another. The rocker arms 8a and 8b are respectively rotatably mounted at their rear end to the bottom frame 5 and/or to the top frame 7—in a manner disclosed below in more detail—and in each case have at their front end rotatable rollers, by means of which they are movably guided in or on the top frame 7 and/or bottom frame 5 in the longitudinal seat direction x. By this movement of the rocker arms 8a and 8b, the height of the top frame 7 over the bottom frame 5 alters, hereinafter denoted in short as the height of the scissors-type stand 3. By means of a spring 12 and preferably a damper, the scissors-type stand 3 is a system which may vibrate and which increases the seating comfort. The principal direction of vibration of the scissors-type stand 3, which in an ideal case corresponds to the vertical, is denoted by z.

The scissors-type stand 3 is, in the present case, able to be displaced by means of seat rails 15 in the longitudinal seat direction x, whereby the vehicle seat 1 is longitudinally adjustable, i.e. its longitudinal seat position may be adjusted. The vehicle seat 1 also has a seat frame 16 which, on the one hand, in its rear region on the top frame 7 is articulated on both sides and, on the other hand, in its front region may be lifted and lowered by means of an inclination adjuster, and thus able to be adjusted in its inclination relative to the scissors-type stand 3. The vehicle seat 1 also has a backrest 17 which is attached to the seat frame 16 (or alternatively to the top frame 7)—in the present case able to be adjusted in inclination.

The two pairs of intersecting rocker arms 8a and 8b, comprise in each case a first rocker arm 8a and a second rocker arm 8b, the inside of the first rocker arm 8a and the outside of the second rocker arm 8b facing one another. The two first rocker arms 8a are fixedly connected to one another at their rear end, in the present case the upper end, by means of a transverse tube 18 which extends parallel to the scissor axis 10 in the transverse seat direction y. The transverse tube 18 is mounted on both sides in each case by means of a bearing mechanism 20 on the top frame 7. Preferably, the two second rocker arms 8b are also fixedly connected to one another at their rear end, in the present case the lower end, by means of a transverse tube 18 which in each case is mounted on both sides by means of a bearing mechanism 20 on the bottom frame 5. In a modified embodiment, the last-mentioned transverse tube 18 is rotatably mounted directly on the bottom frame 5. The other ends of the rocker arms 8a or 8b which correspond to one another are fixedly connected to one another by means of further transverse tubes, the front transverse tubes bearing the rollers.

The top frame 7 (and the bottom frame 5) have a C-shaped profile which is open in the transverse seat direction y toward the transverse tube 18 and on both vehicle seat sides receives the associated bearing mechanism 20. The bearing mechanism 20 has a sliding frame 22 which is fastened to the top frame 7 (or to the bottom frame 5), for example by means of screws. The sliding frame 22 consists, for example, of steel or plastics. The sliding frame 22 is completely open in the transverse seat direction y toward the top frame 7 (or bottom frame 5) (“outwardly”), in order to receive the further component of the bearing mechanism 20, and toward the transverse tube 18 (“inwardly”) is partially open for inserting the end of the transverse tube 18. The bearing mechanism 20 has, moreover, a sliding piece 24 which is movably arranged inside the sliding frame 22. The sliding piece 24 has a cube shape in the present case—apart from surface structures for improving the sliding properties. The sliding piece 24 has a bore extending in the transverse seat direction y, which serves as a transverse tube-receiver 24a, which receives the end—inserted into the sliding frame 22—of the transverse tube 18. The sliding piece 24 preferably consists of plastics, for example POM. The sliding frame 22 in the transverse seat direction y is as wide as the sliding piece 24 and in the longitudinal seat direction x approximately three times as long as the sliding piece 24. In the longitudinal seat direction x in front of and behind the sliding piece 24, inside the sliding frame 22 one respective damping spring 26 is arranged which, on the one hand, is supported on the sliding piece 24 and, on the other hand, on the sliding frame 22. The damping spring 26 in the present case has a hollow profile, with an enclosed undulating line. The damping spring 26 acts both as a spring, i.e. resiliently, and also as a damper, i.e. dissipating energy, and namely respectively in the longitudinal seat direction x. Preferably, the damping spring 26 consists of an elastomer, for example rubber or EPDM. The damping spring 26 may be configured in one piece, for example as a hollow rubber spring.

In a modified embodiment, the transverse tube 18 is directly mounted between the damping springs 26, i.e. without a sliding piece 24. In a further modification, the two damping springs 26 are connected to one another, in particular configured integrally with one another.

Due to the disclosed bearing mechanisms 20, the scissors-type stand 3 (damped) may vibrate in the longitudinal seat direction x, i.e. horizontally. Impulses occurring in the longitudinal seat direction x, for example due to uneven road surfaces or due to the coupling of trailers to the commercial vehicle, or corresponding components thereof in the longitudinal seat direction x, are thus absorbed and damped by the scissors-type stand 3 instead of being transmitted to the occupant. This increases the seating comfort. Depending on where such bearing mechanisms 20 are provided, the horizontal vibrations occur between the top frame 7 and the first rocker arms 8a and/or between the second rocker arms 8b and the bottom frame 5.

On the rear limb of the top frame 7 (and optionally the bottom frame 5)—preferably in the middle—a locking device 30 is arranged, by means of which the transverse tube 18 may be locked to the top frame 7 (or bottom frame 5). The locking device 30 has a support 32, for example made of steel. The support 32 is profiled in a U-shape, the two outer limbs in the longitudinal seat direction x facing to the front, and in turn comprising circular profiled bushing-receivers 32a, which are open at the top in the principal direction of vibration z and namely over an angle of less than 180°. The locking device 30 further comprises a half-bushing 34 which is profiled in the shape of a cylinder and aligned in the transverse seat direction y, and in the principal direction of vibration z is open at the bottom, and namely over an angle of less than 180°. The half-bushing 34 preferably consists of plastics. The half-bushing 34 receives the transverse tube 18 and is able to be inserted in the transverse seat direction y into the two bushing-receivers 32a, and as a result a positive connection being produced in the peripheral direction of the transverse tube 18. The entire locking device 30 may be retrospectively mounted, i.e. when the transverse tube 18 is already mounted by means of bearing mechanisms 20 on the top frame 7 (or bottom frame 5). To this end, in a first step, the support 32, preferably after mounting on the top frame 7 (or bottom frame 5) is arranged on the transverse tube 18, in a second step the half-bushing 34, displaced in the transverse seat direction y relative to the support 32, is mounted on the transverse tube 18, and in a third step the half-bushing 34 is displaced in the transverse seat direction y, until it is positively inserted into the support 32.

The locking device 30 has a locking bar 36, which is movably mounted on the support 32 in the principal direction of vibration z. To this end, a locking bar-sliding pin 37 is provided which is provided with a head (i.e. for example configured as a screw) and is inserted through a slot (support slot 32b) extending in the principal direction of vibration z in the central limb of the support 32 and fastened to the locking bar 36, preferably screwed in. Thus the locking bar 36 is movably guided and secured on the support 32. An engaging spring 38, preferably a coil spring made of spring wire, pretensions the locking bar 36 upwardly relative to the support 32 in the principal direction of vibration z. To this end, the engaging spring 38 is suspended, on the one hand, on the locking bar 36 and, on the other hand, on the support 32.

The support is movably mounted in the longitudinal seat direction on the top frame 7. To this end, a support-sliding pin 39 is provided which is provided with a head (i.e. for example configured as a screw) and is inserted through a frame slot 7b extending in the longitudinal seat direction x, on the upper limb of the C-shaped profiled top frame 7 and fastened to the support 32, preferably screwed in. Thus the support 32 (and thus the entire locking device 30) is movably guided and secured on the top frame 7. To the side of the frame slot 7b and guiding the support 32 in the top frame 7 one respective locking opening 7c is formed into which in each case a locking bar projection 36c of the pretensioned locking bar 36 engages, in order to lock the locking device 30 (without clearance). In order to unlock the locking device 30, a control cable is suspended on the locking bar 36, preferably a Bowden cable, which pulls the locking bar 36 against the force of the engaging spring 38, more specifically the locking bar projections 36c out of the locking openings 7c.

By means of the locking device 30, horizontal vibrations may be prevented or permitted, and namely in a reversible manner according to whether the locking device 30 is locked or unlocked. The locking device 30 in both switching states permits the rotational movement of the transverse tube 18 about its own axis, which occurs with the pivoting movement of the first rocker arms 8a.

While specific embodiments of the invention have been described in detail to illustrate the application of the principles of the invention, it will be understood that the invention may be embodied otherwise without departing from such principles.

1-15. (canceled)

16. A vehicle seat comprising:
a bottom frame;
a top frame;
two first rocker arms;
two second rocker arms, one of the first rocker arms intersecting with one of the second rocker arms to form an intersecting pair with a scissor axis extending in a transverse seat direction and another of the first rocker arms intersecting with another of the second rocker arms to form another intersecting pair with a scissor axis extending in a transverse seat direction, the bottom frame, the top frame, the two first rocker arms and two second rocker arms forming a scissors-type stand that can vibrate; and
a bearing mechanism supporting at least one of the two first rocker arms on the top frame or on the bottom frame so as to be able to rotate and vibrate in a longitudinal seat direction, the bearing mechanism having at least one damping spring elastically absorbing and dampening vibrations in the longitudinal seat direction.

17. The vehicle seat as claimed in claim 16, further comprising:
a transverse tube connecting ends of the two first rocker arms to one another, the two first rocker arms being mounted by the bearing mechanism and by the transverse tube extending in the transverse seat direction, wherein:
the bearing mechanism has at least one sliding frame fastened to the top frame or to the bottom frame and into which one end of the transverse tube is inserted;
the at least one damping spring comprises damping springs arranged in the sliding frame in the longitudinal seat direction in front of and behind the sliding piece; and
the damping springs are each formed of a resilient material which dissipates energy.

18. The vehicle seat as claimed in claim 17, wherein the transverse tube is directly mounted between the damping springs.

19. The vehicle seat as claimed in claim 17, wherein the transverse tube is received by a sliding piece movably arranged in the sliding frame, wherein the damping springs are arranged in the sliding frame, in the longitudinal seat direction in front of and behind the sliding piece.

20. The vehicle seat as claimed in claim 19, wherein the sliding piece receives the transverse tube by means of a transverse tube-receiver.

21. The vehicle seat as claimed in claim 17, wherein the damping springs are formed of an elastomer.

22. The vehicle seat as claimed in claim 21, wherein the damping springs are each configured as a hollow rubber spring.

23. The vehicle seat as claimed in claim 17, wherein the damping springs have a hollow profile with an enclosed undulating line.

24. The vehicle seat as claimed in claim 16, further comprising a locking device wherein the transverse tube may be locked by the locking device to the top frame or to the bottom frame.

25. A commercial vehicle seat comprising:
a bottom frame;
a top frame;
a first side first rocker arm;
a second side first rocker arm;
a first side second rocker arm;
a second side second rocker arm, the first side first rocker arm intersecting with the first side second rocker arm to form a first side intersecting pair with a scissor axis extending in a transverse seat direction and the second side first rocker arm intersecting with the second side second rocker arm to form a second side intersecting pair with a scissor axis extending in a transverse seat direction, the bottom frame, the top frame, the first said second side intersecting pair and the second side intersecting pair forming a scissors-type stand that can vibrate; and
a bearing mechanism supporting at least one of the first side first rocker arm and the second side first rocker arm on the top frame or on the bottom frame for rotation and vibration in a longitudinal seat direction, the bearing mechanism having at least one damping spring elastically absorbing and dampening vibrations of the at least one of the first side first rocker arm and second side first rocker arm in the longitudinal seat direction.

26. The vehicle seat as claimed in claim 25, further comprising:
a transverse tube connecting an end of the first side first rocker arm to an end of the second side first rocker arm, the first side first rocker arm and the second side first rocker arm being mounted by the bearing mechanism and by the transverse tube extending in the transverse seat direction, wherein:
the bearing mechanism has at least one sliding frame fastened to the top frame or to the bottom frame and into which one end of the transverse tube is inserted;
the at least one damping spring comprises damping springs arranged in the sliding frame in the longitudinal seat direction in front of and behind the sliding piece; and
the damping springs are each formed of a resilient material which dissipates energy.

27. The commercial vehicle seat as claimed in claim 26, wherein the transverse tube is directly mounted between the damping springs.

28. The commercial vehicle seat as claimed in claim 26, wherein the transverse tube is received by a sliding piece movably arranged in the sliding frame, wherein the damping springs are arranged in the sliding frame, in the longitudinal seat direction in front of and behind the sliding piece.

29. The commercial vehicle seat as claimed in claim 28, wherein the sliding piece receives the transverse tube by means of a transverse tube-receiver.

30. The commercial vehicle seat as claimed in claim 26, wherein the damping springs are formed of an elastomer.

31. The commercial vehicle seat as claimed in claim 30, wherein the damping springs are each configured as a hollow rubber spring.

32. The commercial vehicle seat as claimed in claim 26, wherein the damping springs have a hollow profile with an enclosed undulating line.

33. The commercial vehicle seat as claimed in claim 25, further comprising a locking device wherein the transverse tube may be locked by the locking device to the top frame or to the bottom frame.

34. A commercial vehicle seat comprising:
a bottom frame;
a top frame;
a first side first rocker arm;
a second side first rocker arm;
a first side second rocker arm;
a second side second rocker arm, the first side first rocker arm intersecting with the first side second rocker arm to form a first side intersecting pair with a scissor axis extending in a transverse seat direction and the second side first rocker arm intersecting with the second side second rocker arm to form a second side intersecting pair with a scissor axis extending in a transverse seat direction, the bottom frame, the top frame, the first said second side intersecting pair and the second side intersecting pair forming a scissors-type stand that can vibrate;
a transverse tube connecting an end of the first side first rocker arm to the second side first rocker arm; and
a bearing mechanism supporting said transverse at least one of the first side first rocker arm and second side first rocker arm on the top frame or on the bottom frame for rotation and vibration in a longitudinal seat direction, the bearing mechanism having at least one damping spring elastically absorbing and dampening vibrations of the one of the first side first rocker arm and second side first rocker arm in the longitudinal seat direction.
